(19) United States
(12) Patent Application Publication
(10) Pub. No.: US 2008/0204356 A1
(43) Pub. Date: Aug. 28, 2008

(54) MULTI-DISPLAY APPARATUS

(75) Inventors: Hong-shik SHIM, Gyeonggi-Do (KR); In-seo KEE, Gyeonggi-Do (KR); Ick-hwan KO, Gyeonggi-Do (KR); Young-gu LEE, Gyeonggi-do (KR)

Correspondence Address: CANTOR COLBURN, LLP, 20 Church Street, 22nd Floor, Hartford, CT, 06103, US

(73) Assignee: SAMSUNG ELECTRONICS CO., LTD, Gyeonggi-Do (KR)

(21) Appl. No.: 11/876,166

(22) Filed: Oct. 22, 2007

(30) Foreign Application Priority Data
Feb. 26, 2007 (KR) 10-2007-0019156

(51) Int. Cl. G09G 5/00

(52) U.S. Cl. 345/1.3

(57) ABSTRACT

Provided is a multi-display apparatus that can mitigate a disconnection of an image and its perspective view at a seam between panels. The multi-display apparatus is characterized in that the two panels are disposed with a step difference so that pixel boundaries of display devices formed on substrates overlap, and a high refractive optical film having a refractive index in a range from 1.2 to 3.0 is formed on one of the two panels, which is farther than the other panel according to a perspective of a viewer. The multi-display apparatus not only improves the disconnection of an image at a seam between the two panels, however, also mitigates a perspective view of the image at the seam due to the step difference between the two panels, and thereby, realizing a large natural and smooth image.

### CROSS-REFERENCE TO RELATED PATENT APPLICATION

This application claims the benefit of Korean Patent Application No. 10-2007-0019156, filed on Feb. 26, 2007, in the Korean Intellectual Property Office, the disclosure of which is incorporated herein in its entirety by reference.

### BACKGROUND OF THE INVENTION

1. Field of the Invention

The present invention relates to a multi-display apparatus that realizes an image by connecting a plurality of panels, and more particularly, to a multi-display apparatus that can minimize a disconnection of an image at seams of the multi-display apparatus.

2. Description of the Related Art

Conventionally, multi-display apparatuses realize a large screen by connecting a plurality of display panels. In the past, a large screen was realized by connecting a plurality of Brown Tubes to form a large collection of TVs. However, recently, due to an increasing demand for a large screen in small mobile apparatuses such as mobile phones or personal digital assistants (PDAs), apparatuses that realize such large screen by connecting flat panel displays such as liquid crystal displays (LCDs), field emission displays (FEDs), plasma display panels (PDPs), and organic light-emitting diodes (LEDs) are being produced.

Conventionally, the multi-display apparatuses are manufactured by connecting a pair of unit panels 10 in parallel, as illustrated in FIG. 1, to realize a multi-screen. However, an image at a seam between the pair of unit panels 10, which are connected with each other, is not smoothly formed since the image is viewed as disconnected. As schematically illustrated in FIG. 1, a flat panel display has a sealing structure in which a display device 12 that forms a pixel is mounted on a substrate glass 11 and a cover glass 13 covering the display device 12 is attached to the substrate glass 11. As such, the cover glass 13 basically has a rim thickness t and the display device 12 is located on an inner portion of the cover glass 13. Therefore, an image separation of as much as a disconnection distance w occurs at the seam between the pair of display devices 12. The disconnection distance w cannot be reduced since the disconnection distance w is inevitably required for the cover glass 13 to cover the display devices 12 in order to protect the display devices 12. Therefore, there is a limitation in improving the disconnection of an image at the seam between the pair of unit panels 10 in the above-described parallel connection structure.

To overcome such limitation as described-above, a structure, as illustrated in FIG. 2, has been disclosed in which a pair of first and second unit panels 21 and 22 is disposed with a step difference and pixel boundaries between the pair of first and second unit panels 21 and 22 are vertically aligned along line L. Hence, after the pair of first and second unit panels 21 and 22 are disposed with the step difference, as illustrated in FIG. 2, a right side boundary surface of a pixel 21b of the first unit panel 21 is aligned with a left side boundary surface of a pixel 22b of the second unit panel 22 along the vertical line L. In such form, the disconnection of an image at a seam between the pair of first and second unit panels 21 and 22 is minimized when the image is seen from above the pair of first and second unit panels 21 and 22.

When the first and second unit panels 21 and 22 are disposed on one another, as illustrated in FIG. 2, it is advantageous for ensuring an image connection; however, there is a perspective difference in a connected image due to a large height difference between the first and second unit panels 21 and 22. That is, since the distances for the light respectively emitted from the first and second unit panels 21b and 22b to reach the eyes of a user are different by as much as the height difference between the first and second unit panels 21 and 22, as the height difference between the first and second unit panels 21 and 22 increases, the image cannot be smoothly viewed due to the perspective difference in the connected image. Thus, as an example of a unit panel, a bottom emission type unit panel in which light is emitted towards the substrates 21a and 22a is shown in FIG. 2. However, there is also height difference in a top emission type unit panel in which light is emitted towards the covers 21c and 22c. Furthermore, the multi-display apparatuses as described above are mostly manufactured in a folder type structure in which a pair of panels is connected with a hinge for mobile convenience. That is, when a multi-display apparatus is carried around, the pair of panels is folded, however, when the multi-display apparatus is used, the pair of panels are unfolded into one screen as illustrated in FIG. 1 or 2. However, an air gap G between the pair of panels, as illustrated in FIG. 3, occurs even when a structural tolerance between the pair of panels is well matched when a stack layer type structure, as illustrated in FIG. 2, is manufactured. Accordingly, the perspective view of the image is further affected at the seam.

Accordingly, to ensure product competitiveness, there is a need to develop a multi-display apparatus that can mitigate a disconnection of an image and its perspective view in terms of becoming disconnected at a seam between panels of the multi-display apparatus.

### SUMMARY OF THE INVENTION

To solve the above and/or other problems, the present invention provides a multi-display apparatus that can simultaneously mitigate a disconnection of an image and its perspective view at a seam between panels.

According to an aspect of the present invention, there is provided a multi-display apparatus that displays a large image by connecting at least two panels, wherein the two panels are disposed with a step difference so that pixel boundaries of display devices formed on substrates overlap, and a high refractive optical film having a refractive index in a range from 1.2 to 3.0 is formed on one of the two panels, which is farther than the other panel according to a perspective of a viewer.

The high refractive optical film may have a transmission in a range from 60 to 99%.

The high refractive optical film may be formed of polycarbonate as a single-layer structure.

The high refractive optical film may be formed of polycarbonate as a multi-layer structure.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of a conventional multi-display apparatus;

FIG. 2 is a cross-sectional view of another conventional multi-display apparatus;

FIG. 3 is an enlarged cross-sectional view of an air gap formed between unit panels of the conventional multi-display apparatus of FIG. 2;

FIG. 4 is a view of a multi-display apparatus according to an embodiment of the present invention; and

FIG. 5 is a cross-sectional view of a connection structure of unit panels used in the multi-display apparatus of FIG. 4, according to an embodiment of the present invention.

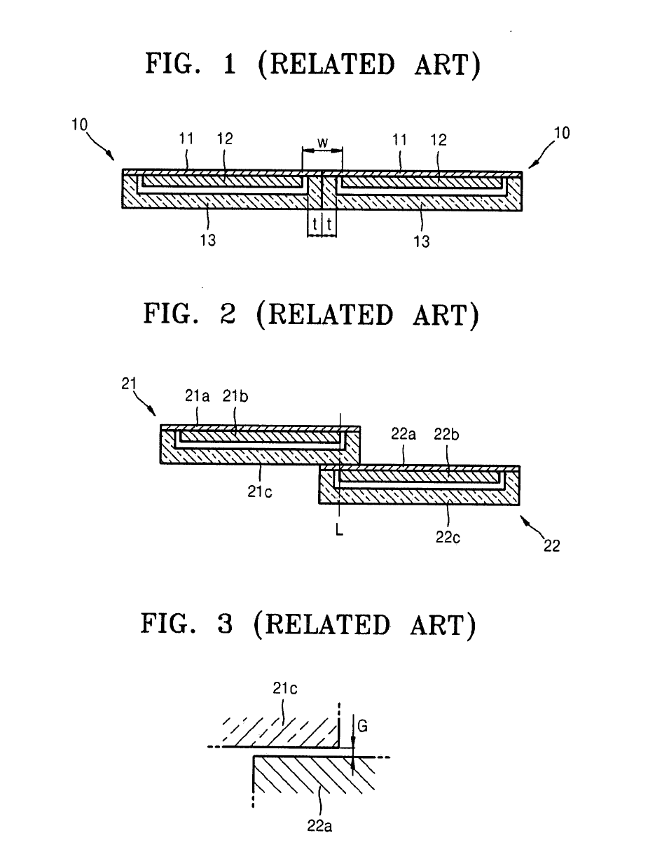

### DETAILED DESCRIPTION OF THE INVENTION

Hereinafter, the present invention will be described in detail by explaining exemplary embodiments of the invention with reference to the attached drawings.

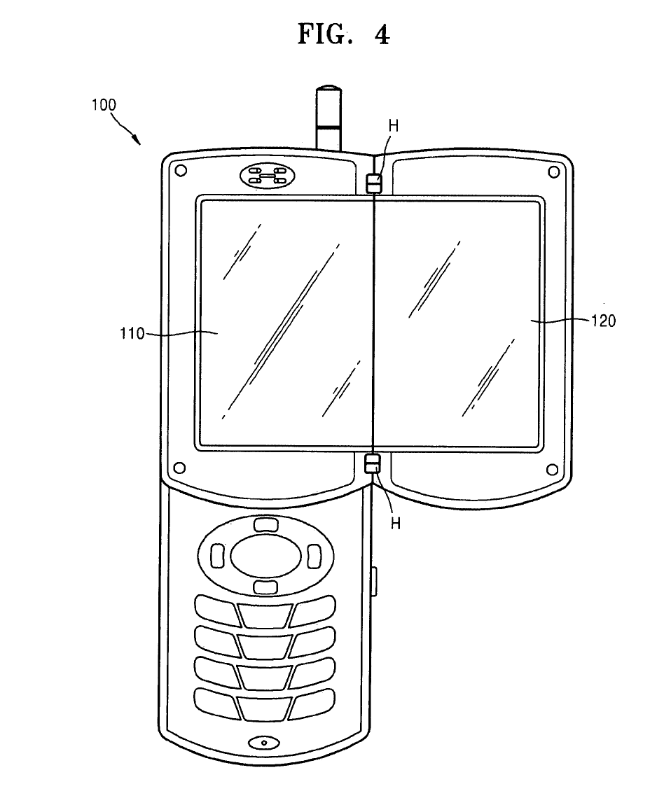

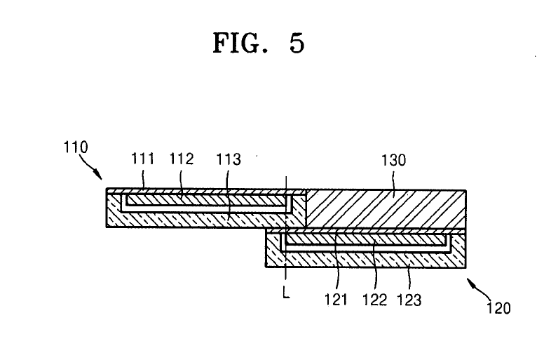

FIG. 4 is a view of a multi-display apparatus 100 according to an embodiment of the present invention. FIG. 5 is a cross-sectional view of a connection structure of unit panels 110 and 120 used in the multi-display apparatus 100 of FIG. 4, according to an embodiment of the present invention. Even if the multi-display apparatus 100 can be made by connecting a plurality of panels, in the present embodiment, for convenience of description, a case of connecting a pair of unit panels 110 and 120 will be described. Also, display devices 112 and 122 that display images are illustrated in simplified forms.

As illustrated in FIG. 5, the unit panels 110 and 120 are configured in a structure in which the display devices 112 and 122, for displaying images, are respectively formed on substrates 111 and 121, and covers 113 and 123 are respectively attached onto the substrates 111 and 121 to respectively surround the display devices 112 and 122.

As illustrated in FIG. 4, the two unit panels 110 and 120 are connected in a foldaway type form that can fold and open using a hinge axis H to form a multi-display, and when the multi-display is opened, the two unit panels 110 and 120 have a step difference as illustrated in FIG. 5. In this structure, pixel boundaries of the display devices 112 and 122 are formed overlapping when the image is viewed from above the unit panels 110 and 120, and thereby, realizing a natural image, as described above.

A high refractive optical film 130 having a refraction index in a range from 1.2 to 3.0 is attached onto the unit panel 120 that is farther than the unit panel 110 according to a perspective of a viewer. The high refractive optical film 130 is formed by stacking films formed of a material such as polycarbonate as a single-layer or multi-layers, and refracts beams emitted from the corresponding display device 122 at a high degree to emit the beams to the outside. Then, when light emitted from the display device 122 passes through the high refractive optical film 130, the viewer perceives that the light is closer to the viewer than an actual distance. Thus, the viewer can sense a similar distance of the light of the two unit panels 110 and 120. That is, the high refractive optical film 130 is used in order to minimize a disconnection of an image at seam of the multi-display apparatus, and thus, the viewer does not perceive a perspective view generated when the unit panels 110 and 120 are disposed with a step difference.

Actually, when the unit panels 110 and 120 are disposed with a step difference of about 0.1 mm, and the high refractive optical film 130, formed of polycarbonate with a thickness of 1 mm and a refractive index of about 1.59, is attached to the unit panel 120 located on a lower portion of the step difference, an image is examined. In this case, an optical illusion occurs such that the image of the unit panel 120 is closer than the actual distance to the viewer, and thus, a whole image looks like an image displayed on the same plane.

According to the multi-display apparatus having a structure described above, the multi-display apparatus can mitigate a disconnection of an image and its perspective view at a seam of the display devices 112 and 122.

Since an image can be transmitted through the high refractive optical film 130, the high refractive optical film 130 is formed, as a single layer or a multi-layer, of a transparent material having a transmission in a range from 60 to 99%. In addition, the layers may be formed only of polycarbonate, or alternatively, may be formed of different materials in addition to polycarbonate. If only the high refractive optical film 130 has a refractive index equal to or greater than 1.2, the image of the unit panel 120 is closer than the actual distance in order to mitigate a perspective view of the image. However, when the refractive index of the high refractive optical film 130 is extremely high, an image can be distorted. Thus, the refractive index of the high refractive optical film 130 may not exceed 3.0. When the high refractive optical film 130 is formed of plastic, such as polycarbonate, if the unit panels 110 and 120 are unfolded into one screen as illustrated in FIG. 5, the plastic high refractive optical film 130 can contact the substrate 111 or the cover 113 of the unit panel 110 located on a higher portion of the step difference. Thus, a contact impact can be mitigated.

The display devices 112 and 122 described in the present invention can be various kinds of flat panel display devices such as liquid crystal displays (LCDs), field emission displays (FEDs), plasma display panels (PDPs), or organic light-emitting diodes (OLEDs).

As described above, a multi-display apparatus according to the present invention can mitigate a disconnection of an image at a seam of panels and a perspective view of an image due to a step difference between the panels of the multi-display apparatus.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A multi-display apparatus that displays a large image by connecting at least two panels, wherein
the two panels are disposed with a step difference so that pixel boundaries of display devices formed on substrates overlap, and
a high refractive optical film having a refractive index in a range from 1.2 to 3.0 is formed on one of the two panels, which is farther than the other panel according to a perspective of a viewer.

2. The apparatus of claim 1, wherein the high refractive optical film has a transmission in a range from 60 to 99%.

3. The apparatus of claim 1, wherein the high refractive optical film is formed of polycarbonate as a single-layer structure.

4. The apparatus of claim 1, wherein the high refractive optical film is formed of polycarbonate as a multi-layer structure.
